(19) United States
(12) Patent Application Publication
(10) Pub. No.: US 2024/0185839 A1
(43) Pub. Date: Jun. 6, 2024

(54) Modular Training for Flexible Attention Based End-to-End ASR

(71) Applicant: Google LLC, Mountain View, CA (US)

(72) Inventors: Kartik AUDHKHASI, Mountain View, CA (US); Bhuvana Ramabhadran, Mt. Kisco, NY (US); Brian Farris, Mountain View, CA (US)

(73) Assignee: Google LLC, Mountain View, CA (US)

(21) Appl. No.: 18/526,148

(22) Filed: Dec. 1, 2023

Related U.S. Application Data
(60) Provisional application No. 63/385,959, filed on Dec. 2, 2022.

(51) Int. Cl. G10L 15/06

(52) U.S. Cl. CPC G10L 15/063; G10L 2015/0635

(57) ABSTRACT

A method for training a modular neural network model includes training only a backbone model to provide a first model configuration of the modular neural network model. The first model configuration includes only the trained backbone model. The method also includes adding an intrinsic sub-model to the trained backbone model. During a fine-tuning training stage, the method includes freezing parameters of the trained backbone model and fine-tuning parameters of the intrinsic sub-model added to the trained backbone model while the parameters of the trained backbone model are frozen to provide a second model configuration that includes the backbone model initially trained during the initial training stage and the intrinsic sub-model having the parameters fine-tuned during the fine-tuning stage.

### CROSS REFERENCE TO RELATED APPLICATIONS

This U.S. patent application claims priority under 35 U.S.C. § 119(e) to U.S. Provisional Application 63/385,959, filed on Dec. 2, 2022. The disclosure of this prior application is considered part of the disclosure of this application and is hereby incorporated by reference in its entirety.

### TECHNICAL FIELD

This disclosure relates to modular training for flexible attention based end-to-end ASR.

### BACKGROUND

Automatic speech recognition (ASR) systems transcribe speech into corresponding text representations. Many ASR systems use an encoder-decoder architecture that is trained by optimizing a final loss function. That is, training each component of the ASR system jointly in an end-to-end manner. A constraint of the end-to-end training approach is that the single trained ASR system may not be suitable across various different applications. That is, the single ASR system may have fixed operating characteristics that are unable to adapt to unique requirements of certain speech-related applications. In some instances, ASR systems integrate additional residual adaptors or residual connections after training to adapt the ASR system to different operating environments. However, integrating these additional components increases the computational and memory resources consumed by the ASR system.

### SUMMARY

One aspect of the disclosure provides a computer-implemented method that when executed on data processing hardware causes the data processing hardware to perform operations for training a modular neural network model. During an initial training stage, the operations include training only a backbone model to provide a first model configuration of the modular neural network model. The first model configuration includes only the trained backbone model. The operations also include adding an intrinsic sub-model to the trained backbone model. During a fine-tuning training stage, the operations include freezing parameters of the trained backbone model and fine-tuning parameters of the intrinsic sub-model added to the trained backbone model while the parameters of the trained backbone model are frozen to provide a second model configuration. Here, the second model configuration includes the backbone model initially trained during the initial training stage and the intrinsic sub-model having the parameters fine-tuned during the fine-tuning stage.

Implementations of the disclosure may include one or more of the following optional features. In some implementations, the backbone model includes a non-attentive neural network that includes existing residual connections, the intrinsic sub-model includes an attention-based sub-model, and the intrinsic sub-model is added to the trained backbone model without requiring any residual adaptors or additional residual connection other than the existing residual connections. In some examples, after fine-tuning parameters of the intrinsic sub-model, the operations include: removing the intrinsic sub-model; adding another intrinsic sub-model to the trained backbone model; and, during another fine-tuning stage, freezing parameters of the trained backbone model and fine-tuning parameters of the other intrinsic sub-model added to the trained backbone while the parameters of the trained backbone model are frozen to provide a third model configuration including the backbone model initially trained during the initial training stage and the other intrinsic sub-model having the parameters fine-tuned during the other fine-tuning stage. In these examples, during the fine-tuning training stage, the parameters of the intrinsic sub-model may be trained on a first domain and/or first application or, during the other fine-tuning training stage, the parameters of the other intrinsic sub-model are trained on a second domain different than the first domain and/or a second application different than the first application. The trained backbone model may be domain-independent. The first domain may be associated with speech recognition in a first language as the second domain is associated with speech recognition in a second language different than the first language.

In some implementations, the modular neural network model includes an end-to-end speech recognition model including an audio encoder and a decoder, training only the backbone model includes updating parameters of the audio encoder or the decoder, and fine-tuning the parameters of the intrinsic sub-model includes updating the parameters of the audio encoder or the decoder. In these implementations, the end-to-end speech recognition model includes a recurrent neural network-transducer (RNN-T) architecture. The operations may further include training another modular neural network including the other one of the audio encoder or the decoder of the end-to-end speech recognition model.

In some examples, the backbone model includes a first half feedforward layer, a convolution layer, a second half feedforward layer, and a layernorm layer, and the intrinsic sub-model includes a stack of one or more multi-head self-attention layers. In these examples, the second model configuration may include the first half feedforward layer, the stack of one or more multi-head self-attention layers, the convolution layer, the second half feedforward layer, and the layernorm layer. During inference, the trained modular neural network is configured to operate in any one of the first model configuration including only the trained backbone model and having the intrinsic sub-model removed, the second model configuration including the backbone model initially trained during the initial training stage and the intrinsic sub-model having the parameters fine-tuned during the fine-tuning stage, or a third model configuration including only the intrinsic sub-model having the parameters fine-tuned during the fine-tuning stage and the trained backbone model removed.

Another aspect of the disclosure provides a system that includes data processing hardware and memory hardware storing instructions that when executed on the data processing hardware causes the data processing hardware to perform operations. During an initial training stage, the operations include training only a backbone model to provide a first model configuration of the modular neural network model. The first model configuration includes only the trained backbone model. The operations also include adding an intrinsic sub-model to the trained backbone model. During a fine-tuning training stage, the operations include freezing parameters of the trained backbone model and fine-tuning parameters of the intrinsic sub-model added to the trained backbone model while the parameters of the trained backbone model are frozen to provide a second model configuration. Here, the second model configuration includes the backbone model initially trained during the initial training stage and the intrinsic sub-model having the parameters fine-tuned during the fine-tuning stage.

Implementations of the disclosure may include one or more of the following optional features. In some implementations, the backbone model includes a non-attentive neural network that includes existing residual connections, the intrinsic sub-model includes an attention-based sub-model, and the intrinsic sub-model is added to the trained backbone model without requiring any residual adaptors or additional residual connection other than the existing residual connections. In some examples, after fine-tuning parameters of the intrinsic sub-model, the operations include: removing the intrinsic sub-model; adding another intrinsic sub-model to the trained backbone model; and, during another fine-tuning stage, freezing parameters of the trained backbone model and fine-tuning parameters of the other intrinsic sub-model added to the trained backbone while the parameters of the trained backbone model are frozen to provide a third model configuration including the backbone model initially trained during the initial training stage and the other intrinsic sub-model having the parameters fine-tuned during the other fine-tuning stage. In these examples, during the fine-tuning training stage, the parameters of the intrinsic sub-model may be trained on a first domain and/or first application or, during the other fine-tuning training stage, the parameters of the other intrinsic sub-model are trained on a second domain different than the first domain and/or a second application different than the first application. The trained backbone model may be domain-independent. The first domain may be associated with speech recognition in a first language as the second domain is associated with speech recognition in a second language different than the first language.

In some implementations, the modular neural network model includes an end-to-end speech recognition model including an audio encoder and a decoder, training only the backbone model includes updating parameters of the audio encoder or the decoder, and fine-tuning the parameters of the intrinsic sub-model includes updating the parameters of the audio encoder or the decoder. In these implementations, the end-to-end speech recognition model includes a recurrent neural network-transducer (RNN-T) architecture. The operations may further include training another modular neural network including the other one of the audio encoder or the decoder of the end-to-end speech recognition model.

In some examples, the backbone model includes a first half feedforward layer, a convolution layer, a second half feedforward layer, and a layernorm layer, and the intrinsic sub-model includes a stack of one or more multi-head self-attention layers. In these examples, the second model configuration may include the first half feedforward layer, the stack of one or more multi-head self-attention layers, the convolution layer, the second half feedforward layer, and the layernorm layer. During inference, the trained modular neural network is configured to operate in any one of the first model configuration including only the trained backbone model and having the intrinsic sub-model removed, the second model configuration including the backbone model initially trained during the initial training stage and the intrinsic sub-model having the parameters fine-tuned during the fine-tuning stage, or a third model configuration including only the intrinsic sub-model having the parameters fine-tuned during the fine-tuning stage and the trained backbone model removed.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is a schematic view of an example automatic speech recognition system.

FIG. 2 is a schematic view of an example speech recognition model.

FIG. 3 is a schematic view of an example backbone model.

FIG. 4 is a schematic view of an example conformer block.

FIG. 5 is a schematic view of an example training process for training the speech recognition model.

FIG. 6 is a schematic view of another example training process for training the speech recognition model.

FIG. 7 is a flowchart of an example arrangement of operations for a computer-implemented method for training a modular neural network.

FIG. 8 is a flowchart of an example arrangement of operations for another computer-implemented method for training a modular neural network.

FIG. 9 is a schematic view of an example computing device that may be used to implement the systems and methods described herein.

Like reference symbols in the various drawings indicate like elements.

### DETAILED DESCRIPTION

End-to-End (E2E) automatic speech recognition (ASR) systems have made tremendous performance advances for a wide variety of speech-related tasks. Typical E2E ASR systems employ an encoder-decoder architecture that is trained jointly. As performance of ASR systems continues to progress, so does the complexity of the acoustic encoders used by the ASR systems. For instance, conformer encoders multiple conformer blocks each including a combination of feedforward, convolutional, and self-attention layers. As such, an E2E training approach of these complex ASR systems is commonly used as it is simple and offers the best word error rate (WER) performance. Consequently, however, the E2E training approach results in a single ASR model that operates with a fixed WER and latency despite the need for ASR models operating at various performance levels of WER and latency. The root of the issue is that the single ASR model architecture cannot easily be modified at inference to operate at a desired performance level of WER and latency. For instance, some speech-related applications may favor ASR models operating with low latency at the cost of WER increases. On the other hand, other speech-related applications may favor ASR models operating with low WER at the cost of latency increases. Despite the above, current E2E training approaches result in single ASR models that are unable to adapt to particular performance requirements.

Accordingly, implementations herein are directed towards methods and systems of a modular training process for flexible attention based E2E ASR. The modular training process includes training only a backbone model to provide a first model configuration of a modular neural network model during an initial training stage. The first model configuration includes only the trained backbone model. The modular training process also includes adding an intrinsic sub-model to the trained backbone model. During a fine-tuning training stage, the training process includes freezing parameters of the trained backbone model and fine-tuning parameters of the intrinsic sub-model added to the trained backbone model while the parameters of the trained backbone model are frozen to provide a second model configuration. The second model configuration includes the backbone model initially trained during the initial training stage and the intrinsic sub-model having the parameters fine-tuned during the fine-tuning stage.

Implementations are further directed towards another modular training process for flexible attention based E2E ASR. Here, during an initial training stage, the modular training process includes training a backbone model while applying a large dropout probability to any intrinsic sub-models residually connected to the backbone model to provide a first model configuration of the modular neural network model. During a fine-tuning training stage, the training process includes fine-tuning parameters of the intrinsic sub-model residually connected to the trained backbone while the parameters of the trained backbone model are frozen to provide a second model configuration. The second model configuration includes the backbone model initially trained during the initial training stage and the intrinsic sub-model having the parameters fine-tuned during the fine-tuning stage.

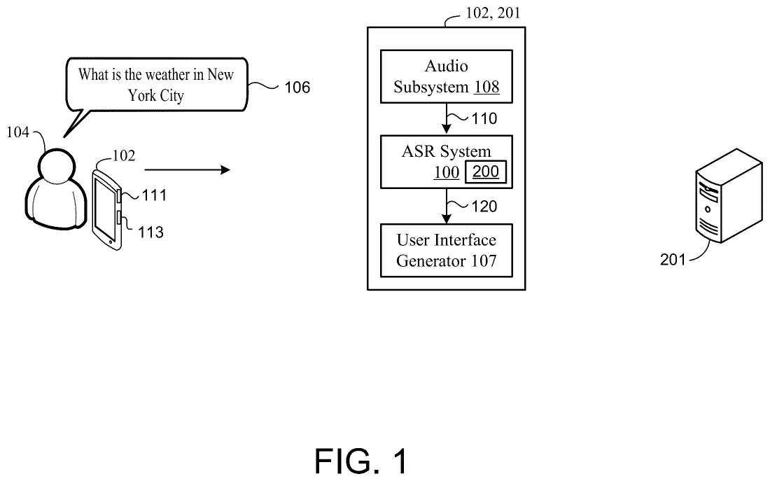

FIG. 1 illustrates an automated speech recognition (ASR) system 100 implementing a modular neural network 200 that resides one a user device 102 of a user 104 and/or on a remote computing device 201 (e.g., one or more servers of a distributed system executing in a cloud-computing environment) in communication with the user device 102. In the example shown, the modular neural network 200 includes an end-to-end ASR model. Thus, the modular neural network 200 may be used interchangeably referred to as the ASR model 200 herein. In some examples, the modular neural network 200 includes only particular portions of the ASR model 200, for example, the audio encoder or the decoder. Although the user device 102 is depicted as a mobile computing device (e.g., a smart phone), the user device 102 may correspond to any type of computing device such as, without limitation, a tablet device, a laptop/desktop computer, a wearable device, a digital assistant device, a smart/speaker display, a smart appliance, an automotive infotainment system, or an Internet-of-Things (IoT) device, and is equipped with data processing hardware 111 and memory hardware 113.

The user device 102 includes an audio subsystem configured to receive an utterance spoken by the user 104 (e.g., the user device 102 may include one or more microphones for recording the spoken utterance 106) and convert the utterance 106 into a corresponding digital format associated with input acoustic frames (i.e., audio features) 110 capable of being processed by the ASR system 100. In the example shown, the user 104 speaks a respective utterance 106 in a natural language of English for the phrase “What is the weather in New York City?” and the audio subsystem 108 converts the utterance 106 into corresponding acoustic frames 110 for input to the ASR system 100. Thereafter, the ASR model 200 receives, as input, the acoustic frames 110 corresponding to the utterance 106, and generates/predicts, as output, a corresponding transcription 120 (e.g., recognition result/hypothesis) of the utterance 106. In the example shown, the user device 102 and/or the remote computing device 201 also executes a user interface generator 107 configured to present a representation of the transcription 120 of the utterance 106 to the user 104 of the user device 102. In some configurations, the transcription 120 output from the ASR system 100 is processed, e.g., by a natural language understanding (NLU) module executing on the user device 102 or the remote computing device 201, to execute a user command. Additionally or alternatively, a text-to-speech system (e.g., executing on any combination of the user device 102 or the remote computing device 201) may convert the transcription 120 into synthesized speech for audible output by another device. For instance, the original utterance 106 may correspond to a message the user 104 is sending to a friend in which the transcription 120 is converted to synthesized speech for audible output to the friend to listen to the message conveyed in the original utterance 106.

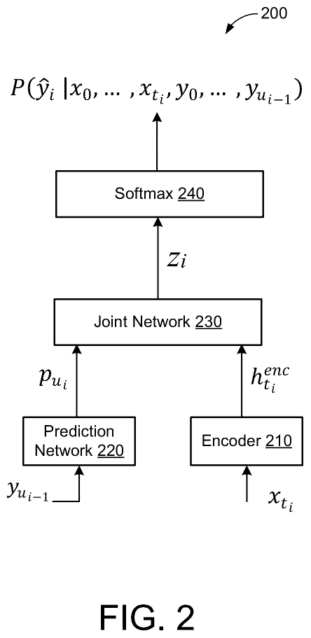

Referring to FIG. 2, an example ASR model 200 may include a Recurrent Neural Network-Transducer (RNN-T) model architecture which adheres to latency constraints associated with interactive applications. The use of the RNN-T model architecture is exemplary, and the ASR model 200 may include other architectures such as transformer-transducer, conformer-transducer, and conformer-encoder model architectures among others. The RNN-T model architecture provides a small computational footprint and utilizes less memory requirements than conventional ASR architectures, making the RNN-T model architecture suitable for performing speech recognition entirely on the user device 102 (e.g., no communication with a remote server is required). The RNN-T model architecture of the ASR model 200 includes an audio encoder 210, a prediction network 220, and a joint network 230. In some examples, the prediction network 220 and the joint network 230 are collectively referred to as a decoder. The audio encoder 210, which is roughly analogous to an acoustic model (AM) in a traditional ASR system, includes a stack of encoder layers. The encoder layers may include a stack of multi-head self-attention layers (e.g., Conformer or Transformer layers) or a recurrent network of stacked Long Short-Term Memory (LSTM) layers. For instance, the audio encoder 210 reads a sequence of d -dimensional feature vectors (e.g., acoustic frames 110 (FIG. 1)) x=(x₁, x₂, . . . , x_{T}), where x₁ ε R_{d}, and produces at each output step a higher-order feature representation. This higher-order feature representation is denoted as h₁^{enc}, . . . , h_{T}^{enc}.

Similarly, the prediction network 220 is also an LSTM network, which, like a language model (LM), processes the sequence of non-blank symbols output by a final Softmax layer 240 so far, y₀, . . . , yᵤᵢ₋₁, into a dense representation pᵤ_{ᵢ}. Finally, the representations produced by the audio encoder 210 and the prediction network 220 are combined by the joint network 230. The prediction network 220 may be replaced by an embedding look-up table to improve latency by outputting looked-up sparse embeddings in lieu of processing dense representations. The joint network 230 then predicts P(yᵢ|xₜ_{ᵢ}, y₀, . . . , yᵤ_{_{i−1}}), which is a distribution over the next output symbol. Stated differently, the joint network 230 generates, at each output step (e.g., time step), a probability distribution over possible speech recognition hypotheses. Here, the “possible speech recognition hypotheses” correspond to a set of output labels each representing a symbol/character in a specified natural language. For example, when the natural language is English, the set of output labels may include twenty-seven (27) symbols, e.g., one label for each of the 26-letters in the English alphabet and one label designating a space. Accordingly, the joint network 230 may output a set of values indicative of the likelihood of occurrence of each of a predetermined set of output labels. This set of values can be a vector and can indicate a probability distribution over the set of output labels. In some cases, the output labels are graphemes (e.g., individual characters, and potentially punctuation and other symbols), but the set of output labels is not so limited. For example, the set of output labels can include wordpieces and/or entire words, in addition to or instead of graphemes. The output distribution of the joint network 230 can include a posterior probability value for each of the different output labels. Thus, if there are 100 different output labels representing different graphemes or other symbols, the output yᵢ of the joint network 230 can include 100 different probability values, one for each output label. The probability distribution can then be used to select and assign scores to candidate orthgraphic elements (e.g., graphemes, wordpieces, and/or words) in a beam search process (e.g., by the Softmax layer 240) for determining the transcription 120.

The Softmax layer 240 may employ any technique to select the output label/symbol with the highest probability in the distribution as the next output symbol predicted by the ASR model 200 at the corresponding output step. In this manner, the RNN-T model architecture of the ASR model 200 does not make a conditional independence assumption, rather the prediction of each symbol is conditioned not only on the acoustics but also on the sequence of labels output so far. The ASR model 200 does assume an output symbol is independent of future acoustic frames 110, which allows the ASR model 200 to be employed in a streaming fashion and/or a non-streaming fashion.

The prediction network 220 may have two 2,048-dimensional LSTM layers, each of which is also followed by 640-dimensional projection layer. Alternatively, the prediction network 220 may include a stack of transformer or conformer blocks, or an embedding look-up table in lieu of LSTM layers. Finally, the joint network 230 may have an input size of 640 and 1024 output units. The softmax layer 240 may be composed of a unified word piece or grapheme set that is generated using all unique word pieces or graphemes in a plurality of training data sets.

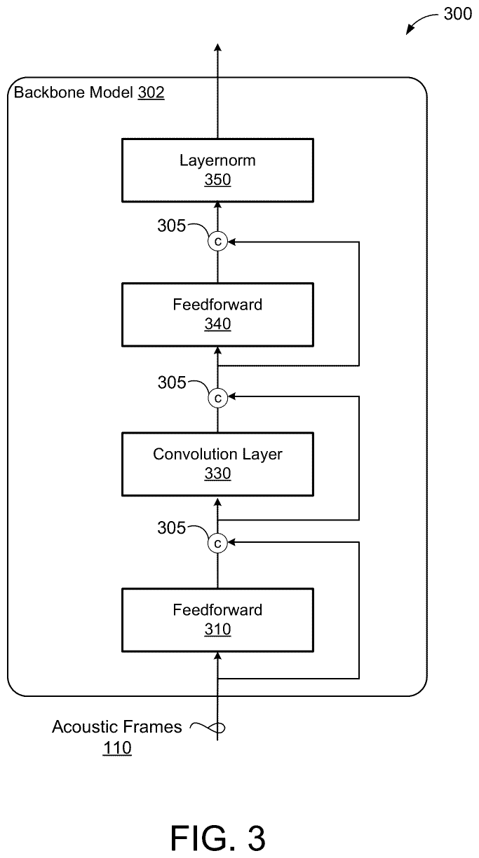

FIG. 3 depicts a first configuration 300 of the encoder layers of the audio encoder 210 (FIG. 2). The first configuration 300 includes a backbone model 302 corresponding to a convolutional network. The backbone model 302 includes a non-attentive neural network that includes existing residual connections. The first configuration 300 may represent each encoder layer of the multiple encoder layers of the audio encoder 210. In particular, the backbone model 302 includes a first half feedforward layer 310, a second half feedforward layer 340, a convolution layer 330 disposed between the first and second half feedforward layers 310, 340, a layernorm layer 350, and concatenation operators 305. The first half feedforward layer 310 processes the sequence of acoustic frames 110. The convolution layer 330 subsamples the output of the first half feedforward layer 310 concatenated with the sequence of acoustic frames 110. Thereafter, the second half feedforward layer 340 receives a concatenation of the output from the convolution layer 330 and the output from the concatenation of the sequence of acoustic frames 110 and the output from first half feedforward layer 310. The layernorm layer 350 processes a concatenation of the output from the second half feedforward layer 340 and the concatenation received by the second half feedforward layer 340. When the audio encoder 210 (FIG. 2) implements the backbone model 302, the output of the backbone model 302 is a higher order feature representation. Notably, the backbone model 302 generates the output without using self-attention because the backbone model 302 does not include self-attention layers.

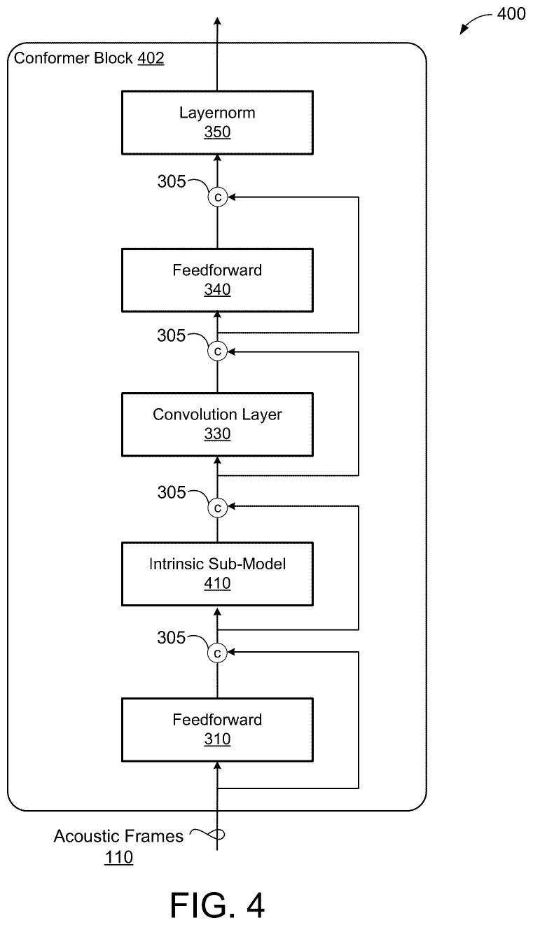

FIG. 4 depicts a second configuration 400 of the encoder layers of the audio encoder 210 (FIG. 2). The second configuration 400 is similar to the first configuration 300 (FIG. 3) with an additional intrinsic sub-model 410 and concatenation operator 305 disposed between the first half feedforward layer 310 and the convolution layer 330. As such, the second configuration 400 includes a conformer block 402 corresponding to a conformer architecture. That is, adding the intrinsic sub-model 410 to the backbone model 302 (FIG. 3) results in the conformer block 402. The intrinsic sub-model 410 includes an attention-based sub-mode. The second configuration 400 may represent each encoder layer of the multiple encoder layers of the audio encoder 210. The intrinsic sub-model 410 may include a stack of one or more multi-head self-attention layers, for example, conformer layers.

In particular, the conformer block 402 includes the first half feedforward layer 310, the second half feedforward layer 340, with the stack of one or more multi-head self-attention layers (e.g., intrinsic sub-model) 410 and the convolution layer 330 disposed between the first and second half feedforward layers 310, 340, the layernorm layer 350, and concatenation operators 305. The first half feedforward layer 310 processes the input sequence of acoustic frames 110. Subsequently, the stack of one or more multi-head self-attention layers 410 receives the sequence of acoustic frames 110 concatenated with the output of the first half feedforward layer 310. Intuitively, the role of the stack of one or more multi-head self-attention layers 410 is to summarize noise context separately for each acoustic frame 110 that is to be enhanced. The convolution layer 330 subsamples a concatenation of the output of the stack of one or more multi-head self-attention layers 410 concatenated with the concatenation received by the stack of one or more multi-head self-attention layers 410. Thereafter, the second half feedforward layer 340 receives a concatenation of the output from the convolution layer 330 concatenated with the concatenation received by the convolution layer 330. The layernorm layer 350 processes a concatenation of the output from the second half feedforward layer 340 with the concatenation received by the second half feedforward layer 340. Accordingly, the conformer block 402 transforms input features x (e.g., acoustic frames 110), using modulation features m, to produce output features y, as follows:

$$\hat{x} = x + r ( m ) ⊙ x + h ( m ) \\ \tilde{x} = \hat{x} + \frac{1}{2} FFN ( \hat{x} ) , \tilde{n} = n + \frac{1}{2} FFN ( n ) \\ {x}^{′} = \tilde{x} + Conv ( \tilde{x} ) , {n}^{′} = \tilde{n} + Conv ( \tilde{n} ) \\ {x}^{″} = {x}^{′} + MHCA ( {x}^{′} , {n}^{′} ) \\ {x}^{″′} = {x}^{′} ⊙ r ( {x}^{″} ) + h ( {x}^{″} ) \\ {x}^{″″} = {x}^{′} + MHCA ( {x}^{′} , {x}^{″′} ) \\ y = LayerNorm ( {x}^{″″} + \frac{1}{2} FFN ( {x}^{″″} ) ) \qquad ( 1 )$$

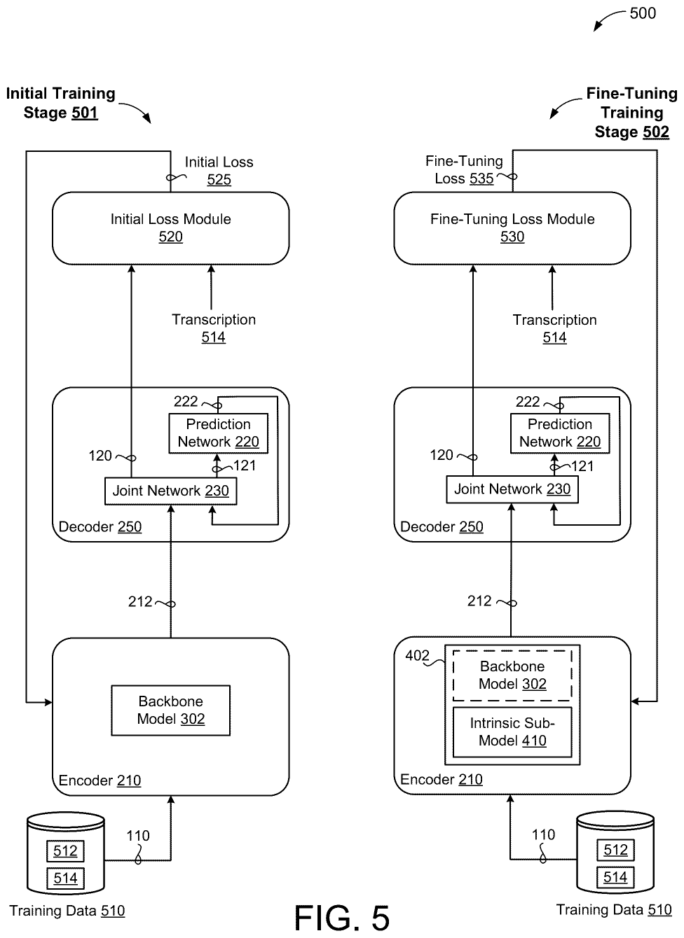

Referring now to FIG. 5, a first training process 500 includes an initial training stage 501 and a fine-tuning training stage 502 to train the ASR model (e.g., modular neural network model) 200. In the example shown, the training process 500 uses modular training to train the audio encoder 210 of the ASR model 200, however, it is understood that the modular training may also be applied to a decoder 250 of the ASR model 200 in addition to, or in lieu of, the audio encoder 210. In particular, the decoder 250 may implement the backbone model 302 during the initial training stage 501 and the conformer block 402 during the fine-tuning training stage 502. The training process 500 uses training data 510 that includes a plurality of training utterances 512 each paired with a corresponding transcription 514. In some examples, each training utterance 512 includes audio-only data and each transcription 514 includes text-only data such that the training utterances 512 paired with transcriptions 514 form labeled training pairs. The training utterances 512 may include speech spoken in any number of different languages and domains. In some implementations, the training utterances 512 include code-mixed utterances (e.g., single utterances spoken in multiple different languages).

The initial training stage 501 of the training process 500 trains only the backbone model 302 to provide the first model configuration 300 for the ASR model 200 to use during inference. That is, during the initial training stage 501, the training process 500 does not train the intrinsic sub-model 410. Thus, the initial training stage 501 trains the backbone model 302 to provide the first model configuration 300 that includes only the trained backbone model 302. In some examples, the initial training stage 501 employs the audio encoder 210, a decoder 250 including the prediction network 220 and the joint network 230, and an initial loss module 520 to train the ASR model 200. During the initial training stage 501, each encoder layer of the audio encoder 210 includes the convolutional network architecture. Stated differently, each encoder layer of the audio encoder 210 corresponds to the backbone model 302.

The audio encoder 210 processes sequences of acoustic frames 110 each corresponding to a respective training utterance 512, and generates, at each output step, a higher order feature representation 212 based on a corresponding sequence of acoustic frames 110. For instance, when the audio encoder 210 operates in a streaming fashion, the audio encoder 210 generates a corresponding higher order feature representation 212 for each corresponding acoustic frame 110 in the sequence of acoustic frames 110. On the other hand, when the audio encoder 210 operates in a non-streaming fashion (e.g., receives additional right context), the audio encoder 210 generates a corresponding higher order feature representation 212 for one or more acoustic frames 110 in the sequence of acoustic frames 110. Notably, since the audio encoder 210 includes the backbone model 302 (e.g., convolutional network architecture) during the initial training stage 501, the audio encoder 210 generates the higher order feature representations 212 using convolution and without using self-attention.

The decoder 250 is configured to generate speech recognition results 120 for each higher order feature representation 212 generated by the audio encoder 210. The decoder 250 includes the prediction network 220 and the joint network 230. Thus, the joint network 230 is configured to receive, as input, a dense representation 222 generated by the prediction network 220 and the higher order feature representation 212 generated by the encoder 10 and generate, at each output step, the speech recognition result 120 for the higher order feature representation. That is, the joint network 230 generates the speech recognition result 120 based on the higher order feature representation 212 and the dense representation 222. In some implementations, the prediction network 220 receives, as input, a sequence of non-blank symbols 121 output by the final softmax layer of the joint network 230 and generates, at each output step, the dense representation 222. That is, the joint network 230 receives the dense representation 222 corresponding to a respective previous speech recognition result 120 and generates a current speech recognition result 120 using the dense representation 222 and the higher order feature representation 212.

The initial loss module 520 is configured to determine an initial training loss 525 for each training utterance 512 of the training data 510. In particular, for each respective training utterance 512, the initial loss module 520 compares the speech recognition result 120 generated for the respective training utterance 512 with the corresponding transcription 514. The initial training stage 501 updates parameters of the backbone model 302 based on the initial training loss 525 determined for each training utterance 512. More specifically, the initial training stage 501 updates parameters of at least one of the first half feedforward layer 310, the convolution layer 330, the second half feedforward layer 340, or the layernorm layer 350.

After the initial training stage 501, the training process 500 adds the intrinsic sub-model 410 to the trained backbone model 302. Notably, the training process 500 adds the intrinsic sub-model 410 to the trained backbone model 302 without requiring any residual adaptors or additional residual connections other than the existing residual connections of the backbone model 302. That is, the training process 500 adds the intrinsic sub-model (e.g., multi-head self-attention layers) 410 to each encoder layer of the stack of encoder layers of the audio encoder 210. As a result, each encoder layer of the audio encoder 210 includes conformer block 402 corresponding to the conformer architecture. Simply put, the stack of encoder layers correspond to a stack of conformer layers. The fine-tuning training stage 502 freezes parameters of the first half feedforward layer 310, the convolution layer 330, the second half feedforward layer 340, and the layernorm layer 350 such that the frozen parameters are not trained during the fine-tuning training stage 502 (e.g., denoted by the dashed lines). That is, the fine-tuning training stage 502 fine-tunes parameters of the intrinsic sub-model 410 that was added to the trained backbone model 302 while parameters of the trained backbone model 302 to provide the second model configuration 400 (FIG. 4).

The fine-tuning training stage 502 employs the audio encoder 210, the decoder 250 including the prediction network 220 and the joint network 230, and a fine-tuning loss module 530. During the fine-tuning training stage 502, each encoder layer of the audio encoder 210 includes the conformer block 402 architecture. Stated differently, each encoder layer of the audio encoder 210 includes the intrinsic sub-model 410 added to the backbone model 302 during the fine-tuning training stage 502. The audio encoder 210 processes sequences of acoustic frames 110 each corresponding to a respective training utterance 512, and generates, at each output step, a higher order feature representation 212 based on a corresponding sequence of acoustic frames 110. For instance, when the audio encoder 210 operates in a streaming fashion, the audio encoder 210 generates a higher order feature representation 212 for each corresponding acoustic frame 110 in the sequence of acoustic frames 110. On the other hand, when the audio encoder 210 operates in a non-streaming fashion (e.g., receives additional right context), the audio encoder 210 generates a higher order feature representation 212 for one or more acoustic frames 110 in the sequence of acoustic frames 110. Notably, since the audio encoder 210 includes the intrinsic sub-model 410 added to the backbone model 302 during the fine-tuning training stage 502, the audio encoder 210 generates the higher order feature representations 212 using self-attention.

The decoder 250 is configured to generate speech recognition results 120 for each higher order feature representation 212 generated by the audio encoder 210. The decoder 250 includes the prediction network 220 and the joint network 230. Thus, the joint network 230 is configured to receive, as input, a dense representation 222 generated by the prediction network 220 and the higher order feature representation 212 generated by the encoder 10 and generate, at each output step, the speech recognition result 120 for the higher order feature representation 212. That is, the joint network 230 generates the speech recognition result 120 based on the higher order feature representation 212 and the dense representation 222. In some implementations, the prediction network 220 receives, as input, a sequence of non-blank symbols 121 output by the final softmax layer of the joint network 230 and generates, at each output step, a dense representation 222. That is, the joint network 230 receives the dense representation 222 for the previous speech recognition result 120 and generates a subsequent speech recognition result 120 using the dense representation 222.

The fine-tuning loss module 530 is configured to determine a fine-tuning loss 535 for each training utterance 512 of the training data 510. In particular, for each respective training utterance 512, the fine-tuning loss module 530 compares the speech recognition result 120 generated for the respective training utterance 512 with the corresponding transcription 514. The fine-tuning training stage 502 updates parameters of the intrinsic sub-model 410 based on the fine-tuning loss 535 determined for each training utterance 512 while parameters of the backbone model 302 remain frozen. More specifically, the fine-tuning training stage 502 updates parameters of the intrinsic sub-model 410 while parameters of the first half feedforward layer 310, the convolution layer 330, the second half feedforward layer 340, and the layernorm layer 350 remain frozen.

After the training process 500 trains the ASR model 200 using the initial training stage 501 and the fine-tuning training stage 502, the ASR model 200 may be adapted during inference. That is, the first configuration 300 includes the backbone model 302 which does not include self-attention layers, and thus, the ASR model 200 using the first configuration 300 operates at a lower latency, but at higher WER. In contrast, the second configuration 400 includes the intrinsic sub-model 410 which does include self-attention layers, and thus, the ASR model 200 using the second configuration 400 operates at a lower WER, but at increased latency. In some implementations, the ASR model 200 may operate using a third configuration which includes only the intrinsic sub-model 410 with the backbone model 302 removed. However, drawbacks of the training process 500 includes that weights of the intrinsic sub-model 410 are randomly initialized during the fine-tuning training stage 502 when the weights of the backbone model 302 have already been trained during the initial training stage. Moreover, the fine-tuning training stage 502 starts off with a higher WER because the initial training stage 501 does not include use any self-attention.

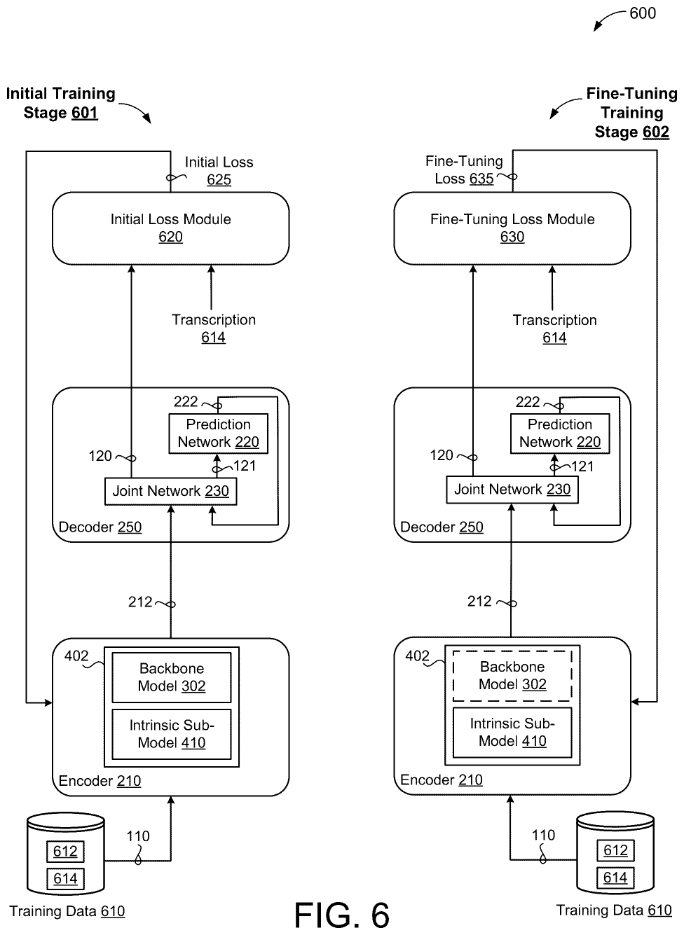

Referring now to FIG. 6, a second training process 600 includes an initial training stage 601 and a fine-tuning training stage 602 to train the ASR model (e.g., modular neural network model) 200. The second training process 600 is similar to the first training process 500 (FIG. 5) except that during the initial training stage 601 of the second training process 600 the audio encoder 210 includes the backbone model 302 and the intrinsic sub-model 410 (in contrast to only the backbone model 302). As will become apparent, the initial training stage 601 of the second training process 600 applies dropout to the intrinsic sub-model 410. In the example shown, the training process 600 uses modular training to train the audio encoder 210 of the ASR model 200, however, it is understood that the modular training may also be applied to a decoder 250 of the ASR model 200 in addition to, or in lieu of, the audio encoder 210. The training process 600 uses training data 610 that includes a plurality of training utterances 612 each paired with a corresponding transcription 614. The training data 610 may be the same or different than the training data 510 (FIG. 5). In some examples, each training utterance 612 includes audio-only data and each transcription 614 includes text-only data such that the training utterances 612 paired with transcriptions 614 form labeled training pairs. The training utterances 612 may include speech spoken in any number of different languages and domains. In some implementations, the training utterances 612 include code-mixed utterances (e.g., single utterances spoken in multiple different languages).

The initial training stage 601 of the training process 600 trains the backbone model 302 while applying a large dropout probability to any intrinsic sub-models 410 residually connected to the backbone model 302. Here, applying dropout means disregarding certain nodes from the intrinsic sub-model 410 at random during training. Thus, the dropout probability may range from 1.0 where all nodes of the intrinsic sub-model 410 are disregarded during training such that the audio encoder 210 uses only the backbone model 302 to 0.0 where zero nodes of the intrinsic sub-model 410 are disregarded during training such that the audio encoder 210 includes conformer network architecture. The initial training stage 601 may apply any dropout probability to the intrinsic sub-model 410. For example, the initial training stage 601 may apply a dropout probability of 0.9. In some examples, the initial training stage 601 employs the audio encoder 210, the decoder 250 including the prediction network 220 and the joint network 230, and an initial loss module 620 to train the ASR model 200. During the initial training stage 601, each encoder layer of the audio encoder 210 includes the backbone model 302 with the added intrinsic sub-model 410 corresponding to the conformer block 402.

The audio encoder 210 processes sequences of acoustic frames 110 each corresponding to a respective training utterance 612, and generates, at each output step, a higher order feature representation 212 based on a corresponding sequence of acoustic frames 110. The audio encoder 210 generates the higher order feature representation 212 while applying a large dropout probability to the intrinsic sub-model 410. When the audio encoder 210 operates in a streaming fashion, the audio encoder 210 generates a corresponding higher order feature representation 212 for each corresponding acoustic frame 110 in the sequence of acoustic frames 110. On the other hand, when the audio encoder 210 operates in a non-streaming fashion (e.g., receives additional right context), the audio encoder 210 generates a corresponding higher order feature representation 212 for one or more acoustic frames 110 in the sequence of acoustic frames 110. Notably, since the audio encoder 210 includes the backbone model 302 and the intrinsic sub-model 410 during the initial training stage 601, the audio encoder 210 generates the higher order feature representations 212 using convolution and a variable amount of self-attention dependent upon the dropout probability.

The decoder 250 is configured to generate speech recognition results 120 for each higher order feature representation 212 generated by the audio encoder 210. The decoder 250 includes the prediction network 220 and the joint network 230. Thus, the joint network 230 is configured to receive, as input, a dense representation 222 generated by the prediction network 220 and the higher order feature representation 212 generated by the encoder 10 and generate, at each output step, the speech recognition result 120 for the higher order feature representation. That is, the joint network 230 generates the speech recognition result 120 based on the higher order feature representation 212 and the dense representation 222. In some implementations, the prediction network 220 receives, as input, a sequence of non-blank symbols 121 output by the final softmax layer of the joint network 230 and generates, at each output step, the dense representation 222. That is, the joint network 230 receives the dense representation 222 corresponding to a respective previous speech recognition result 120 and generates a current speech recognition result 120 using the dense representation 222 and the higher order feature representation 212.

The initial loss module 620 is configured to determine an initial training loss 625 for each training utterance 612 of the training data 610. In particular, for each respective training utterance 612, the initial loss module 620 compares the speech recognition result 120 generated for the respective training utterance 612 with the corresponding transcription 614. The initial training stage 601 updates parameters of the backbone model 302 and/or the intrinsic sub-model 410 based on the initial training loss 625 determined for each training utterance 612.

After the initial training stage 601, the fine-tuning training stage 602 of the training process 600 does not apply the large dropout probability to the intrinsic sub-models 410. The fine-tuning training stage 602 freezes parameters of the trained backbone model 302 such that only parameters of the intrinsic sub-model 410 are updated during the fine-tuning training stage 602. The fine-tuning training stage 602 employs the audio encoder 210, the decoder 250 including the prediction network 220 and the joint network 230, and a fine-tuning loss module 630. The audio encoder 210 processes sequences of acoustic frames 110 each corresponding to a respective training utterance 612, and generates, at each output step, a higher order feature representation 212 based on a corresponding sequence of acoustic frames 110. For instance, when the audio encoder 210 operates in a streaming fashion, the audio encoder 210 generates a higher order feature representation 212 for each corresponding acoustic frame 110 in the sequence of acoustic frames 110. On the other hand, when the audio encoder 210 operates in a non-streaming fashion (e.g., receives additional right context), the audio encoder 210 generates a higher order feature representation 212 for one or more acoustic frames 110 in the sequence of acoustic frames 110. Notably, since the audio encoder 210 includes the intrinsic sub-model 410 and the backbone model 302 without applying the large dropout probability (e.g., dropout probability equal to zero) during the fine-tuning training stage 602, the audio encoder 210 generates the higher order feature representations 212 using self-attention.

The decoder 250 is configured to generate speech recognition results 120 for each higher order feature representation 212 generated by the audio encoder 210. The decoder 250 includes the prediction network 220 and the joint network 230. Thus, the joint network 230 is configured to receive, as input, a dense representation 222 generated by the prediction network 220 and the higher order feature representation 212 generated by the encoder 10 and generate, at each output step, the speech recognition result 120 for the higher order feature representation 212. That is, the joint network 230 generates the speech recognition result 120 based on the higher order feature representation 212 and the dense representation 222. In some implementations, the prediction network 220 receives, as input, a sequence of non-blank symbols 121 output by the final softmax layer of the joint network 230 and generates, at each output step, a dense representation 222. That is, the joint network 230 receives the dense representation 222 for the previous speech recognition result 120 and generates a subsequent speech recognition result 120 using the dense representation 222.

The fine-tuning loss module 630 is configured to determine a fine-tuning loss 635 for each training utterance 612 of the training data 610. In particular, for each respective training utterance 612, the fine-tuning loss module 630 compares the speech recognition result 120 generated for the respective training utterance 612 with the corresponding transcription 614. The fine-tuning training stage 602 updates parameters of the intrinsic sub-model 410 based on the fine-tuning loss 635 determined for each training utterance 612 while parameters of the backbone model 302 remain frozen. More specifically, the fine-tuning training stage 602 updates parameters of the intrinsic sub-model 410 while parameters of the first half feedforward layer 310, the convolution layer 330, the second half feedforward layer 340, and the layernorm layer 350 remain frozen.

After the training process 600 trains the ASR model 200 using the initial training stage 601 and the fine-tuning training stage 602, the ASR model 200 may be adapted during inference. That is, the first configuration 300 includes the backbone model 302 which does not include self-attention layers, and thus, the ASR model 200 using the first configuration 300 operates at a lower latency, but at higher WER. In contrast, the second configuration 400 includes the intrinsic sub-model 410 which does include self-attention layers, and thus, the ASR model 200 using the second configuration 400 operates at a lower WER, but at increased latency. In some implementations, the ASR model 200 may operate using a third configuration which includes only the intrinsic sub-model 410 with the backbone model 302 removed. Advantageously, using the training process 600 causes weights of the intrinsic sub-model 410 to be partially trained during the fine-tuning training stage 602 because of the large dropout probability applied during the initial training stage 601. Moreover, the fine-tuning training stage 602 starts off with a lower WER because the initial training stage 601 does include limited self-attention because of the high dropout probability applied to the intrinsic sub-model 410 during the initial training stage 601.

Referring now to FIGS. 5 and 6, in some implementations, the training processes 500, 600 remove the intrinsic sub-model 410 after fine-tuning parameters of the intrinsic sub-model 410 during the fine-tuning training stages 502, 602, and add another intrinsic sub-model 410 to the trained backbone model 302. Here, the training processes 500, 600 employ another fine-tuning training stage 502, 602 that freezes parameters of the trained backbone model 302 and fine-tunes parameters of the other intrinsic sub-model 410 added to the trained backbone model 302 while the parameters of the trained backbone model 302 are frozen to provide another model configuration. In particular, during the first fine-tuning training stage 502, 602, the parameters of the intrinsic sub-model 410 are trained on training data corresponding to a first domain and/or first application and during the other fine-tuning training stage 502, 602, the parameters of the other intrinsic sub-model 410 are trained on a second domain different than the first domain and/or a second application different than the first application. Notably, the trained backbone model 302 is domain-independent and the training processes 500, 600 may train any number of different intrinsic sub-models 410 on any number of different domains or applications.

For example, the first domain may be associated with speech recognition in a first language and the second domain is associated with speech recognition in a second language different than the first language. In another example, the first domain may be associated with speech recognition for utterances including a single language and the second domain is associated with speech recognition for utterances including code-switched utterances. In yet another example, the first domain may be associated with streaming speech recognition while the second domain is associated with non-streaming speech recognition. Advantageously, any number of different intrinsic sub-models 410 may be added to the trained backbone model 302 and adapted towards a specific speech-related task.

Accordingly, during inference, the trained ASR model 200 may be configured to operate in any of a number of configurations. The ASR model 200 may operate in a first model configuration 300 that includes only the trained backbone model 302 whereby the intrinsic sub-model 410 is removed thereby providing low latency at increased WER. In some examples, the ASR model 200 operates in the second model configuration 400 that includes backbone model 302 initially trained during the initial training stage 501, 601 and the intrinsic sub-model 410 having the parameters fine-tuned during the fine-tuning training stage 502, 602. In other examples, the ASR model 200 operates in a third configuration that includes only the intrinsic sub-model 410 having the parameters fine-tuned during the fine-tuning training stage 502, 602 and the trained backbone model 302 removed. In yet other examples, the ASR model 200 operates with the intrinsic sub-model 410 having the parameters fine-tuned during the fine-tuning training stage 502, 602 for only a sub-set of layers. For instance, an ASR model 200 with an audio encoder 210 having 8 encoder layers may use the trained backbone model 302 only for the first 4 layers and use the trained backbone model 302 with the added intrinsic sub-model 410 for the remaining 4 layers. In short, by operating in any one of these configurations, the ASR model 200 is able to adapt to any trade-off between WER and latency best suited for each particular task. Notably, the ASR model 200 is able to adapt to these different configurations without requiring any residual adaptors or additional residual connections other than the existing residual connections.

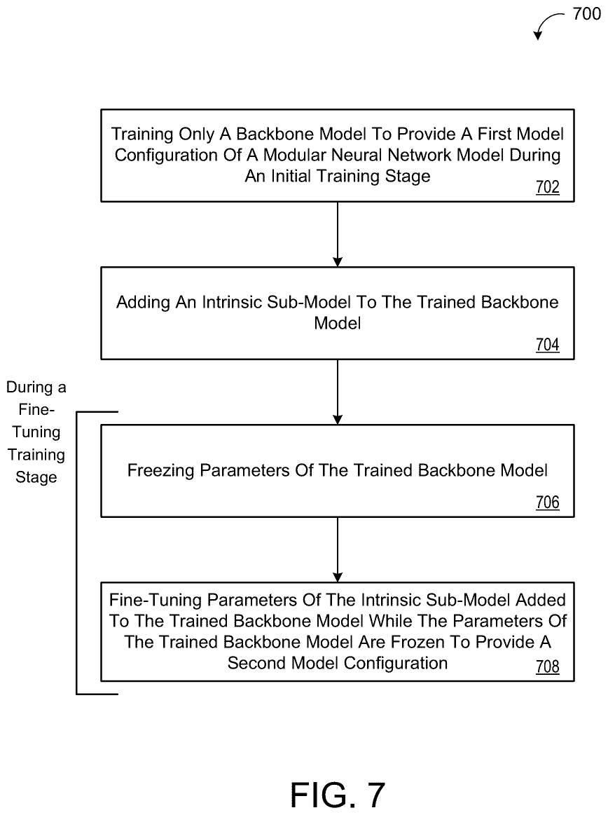

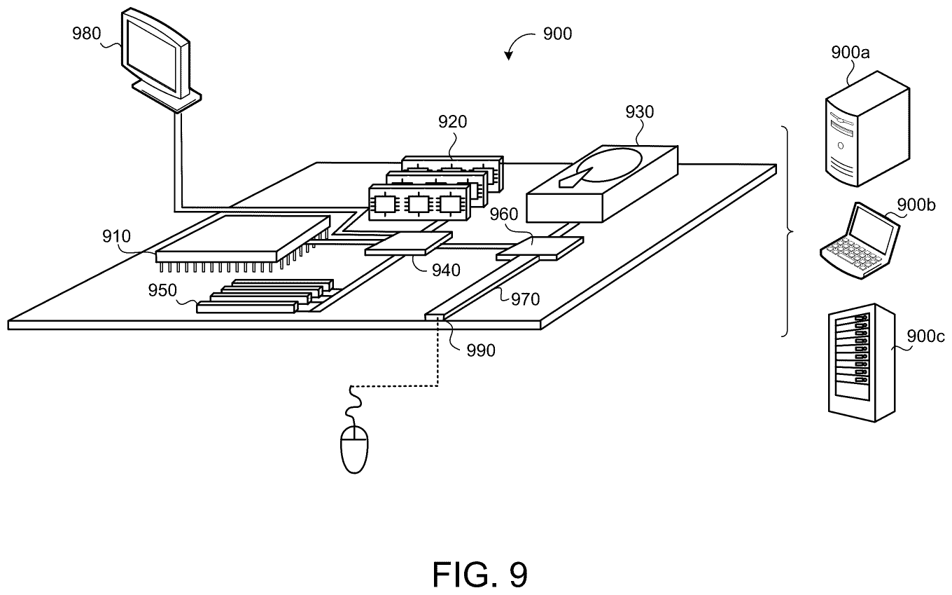

FIG. 7 is a flowchart of an example arrangement of operations for a method 700 for training a modular neural network 200. The method 700 may execute on data processing hardware 910 (FIG. 9) using instructions stored on memory hardware 920 (FIG. 9). The data processing hardware 910 and the memory hardware 920 may reside on the user device 102 and/or the remote computing device 201 each corresponding to a computing device 900 (FIG. 9).

At operation 702, the method 700 includes training only a backbone model 302 to provide a first model configuration 300 of the modular neural network 200 during an initial training stage 501. The first model configuration 300 includes only the trained backbone model 302. At operation 704, the method 700 includes adding an intrinsic sub-model 410 to the trained backbone model 302. During a fine-tuning training stage 502, the method 700 performs operations 706 and 708. At operation 706, the method 700 includes freezing parameters of the trained backbone model 302 and fine-tuning parameters of the intrinsic sub-model 410 added to the trained backbone model 302 while the parameters of the trained backbone model 302 model are frozen to provide a second model configuration 400. Here, the second model configuration 400 includes the backbone model 302 initially trained during the initial training stage 501 and the intrinsic sub-model 410 having the parameters fine-tuned during the fine-tuning training stage 502.

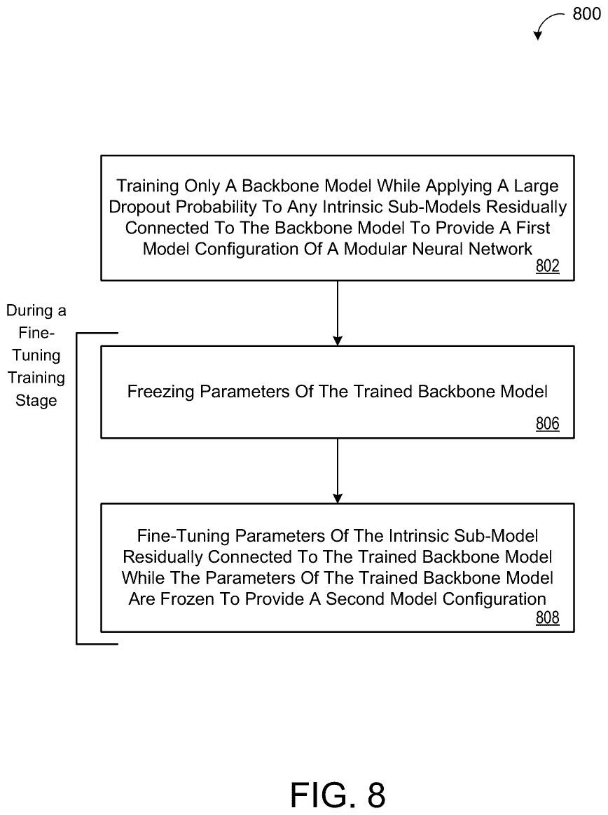

FIG. 8 is a flowchart of an example arrangement of operations for another method 800 for training the modular neural network 200. The method 800 may execute on the data processing hardware 910 (FIG. 9) using instructions stored on the memory hardware 920 (FIG. 9). The data processing hardware 910 and the memory hardware 920 may reside on the user device 102 and/or the remote computing device 201 each corresponding to the computing device 900 (FIG. 9).

At operation 802, the method 800 includes, during an initial training stage 601, training a backbone model 302 while applying a large dropout probability to any intrinsic sub-models 410 residually connected to the backbone model 302 to provide a first model configuration 300 of the modular neural network model 200. That is, even though the initial training stage 601 includes the intrinsic sub-model 410, the initial training stage 601 provides the first model configuration 300 including only the trained backbone model 302. During a fine-tuning training stage 602, the method 800 performs operations 804 and 806. At operation 804, the method 800 includes freezing parameters of the trained backbone model 302. At operation 806, the method 800 includes fine-tuning parameters of the intrinsic sub-model 410 residually connected to the trained backbone model 302 while the parameters of the trained backbone model 302 are frozen to provide a second model configuration 400. Here, the second model configuration 400 includes the backbone model 302 initially trained during the initial training stage 601 and the intrinsic sub-model 410 having the parameters fine-tuned during the fine-tuning stage 602.

FIG. 9 is a schematic view of an example computing device 900 that may be used to implement the systems and methods described in this document. The computing device 900 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 900 includes a processor 910, memory 920, a storage device 930, a high-speed interface/controller 940 connecting to the memory 920 and high-speed expansion ports 950, and a low speed interface/controller 960 connecting to a low speed bus 970 and a storage device 930. Each of the components 910, 920, 930, 940, 950, and 960, are interconnected using various busses, and may be mounted on a common motherboard or in other manners as appropriate. The processor 910 can process instructions for execution within the computing device 900, including instructions stored in the memory 920 or on the storage device 930 to display graphical information for a graphical user interface (GUI) on an external input/output device, such as display 980 coupled to high speed interface 940. In other implementations, multiple processors and/or multiple buses may be used, as appropriate, along with multiple memories and types of memory. Also, multiple computing devices 900 may be connected, with each device providing portions of the necessary operations (e.g., as a server bank, a group of blade servers, or a multi-processor system).

The memory 920 stores information non-transitorily within the computing device 900. The memory 920 may be a computer-readable medium, a volatile memory unit(s), or non-volatile memory unit(s). The non-transitory memory 920 may be physical devices used to store programs (e.g., sequences of instructions) or data (e.g., program state information) on a temporary or permanent basis for use by the computing device 900. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 930 is capable of providing mass storage for the computing device 900. In some implementations, the storage device 930 is a computer-readable medium. In various different implementations, the storage device 930 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer- or machine-readable medium, such as the memory 920, the storage device 930, or memory on processor 910.

The high speed controller 940 manages bandwidth-intensive operations for the computing device 900, while the low speed controller 960 manages lower bandwidth-intensive operations. Such allocation of duties is exemplary only. In some implementations, the high-speed controller 940 is coupled to the memory 920, the display 980 (e.g., through a graphics processor or accelerator), and to the high-speed expansion ports 950, which may accept various expansion cards (not shown). In some implementations, the low-speed controller 960 is coupled to the storage device 930 and a low-speed expansion port 990. The low-speed expansion port 990, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 900 may be implemented in a number of different forms, as shown in the figure. For example, it may be implemented as a standard server 900a or multiple times in a group of such servers 900a, as a laptop computer 900b, or as part of a rack server system 900c.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A number of implementations have been described. Nevertheless, it will be understood that various modifications may be made without departing from the spirit and scope of the disclosure. Accordingly, other implementations are within the scope of the following claims.

What is claimed is:

1. A computer-implemented method for training a modular neural network model, the computer-implemented method executed on data processing hardware that causes the data processing hardware to perform operations comprising:
during an initial training stage, training only a backbone model to provide a first model configuration of the modular neural network model, the first model configuration comprising only the trained backbone model;
adding an intrinsic sub-model to the trained backbone model; and
during a fine-tuning training stage:
freezing parameters of the trained backbone model; and
fine-tuning parameters of the intrinsic sub-model added to the trained backbone model while the parameters of the trained backbone model are frozen to provide a second model configuration, the second model configuration comprising the backbone model initially trained during the initial training stage and the intrinsic sub-model having the parameters fine-tuned during the fine-tuning stage.

2. The computer-implemented method of claim 1, wherein:
the backbone model comprises a non-attentive neural network comprising existing residual connections;
the intrinsic sub-model comprises an attention-based sub-model; and
the intrinsic sub-model is added to the trained backbone model without requiring any residual adaptors or additional residual connection other than the existing residual connections.

3. The computer-implemented method of claim 1, wherein the operations further comprise, after fine-tuning parameters of the intrinsic sub-model:
removing the intrinsic sub-model;
adding another intrinsic sub-model to the trained backbone model; and
during another fine-tuning training stage:
freezing parameters of the trained backbone model; and
fine-tuning parameters of the other intrinsic sub-model added to the trained backbone model while the parameters of the trained backbone model are frozen to provide a third model configuration, the third model configuration comprising the backbone model initially trained during the initial training stage and the other intrinsic sub-model having the parameters fine-tuned during the other fine-tuning stage.

4. The computer-implemented method of claim 3 wherein:
during the fine-tuning training stage, the parameters of the intrinsic sub-model are trained on a first domain and/or first application; or
during the other fine-tuning training stage, the parameters of the other intrinsic sub-model are trained on a second domain different than the first domain and/or a second application different than the first application.

5. The computer-implemented method of claim 4, wherein the trained backbone model is domain-independent.

6. The computer-implemented method of claim 4, wherein the first domain is associated with speech recognition in a first language and the second domain is associated with speech recognition in a second language different than the first language.

7. The computer-implemented method of claim 1, wherein:
the modular neural network model comprises an end-to-end speech recognition model comprising an audio encoder and a decoder;
training only the backbone model comprises updating parameters of the audio encoder or the decoder; and
fine-tuning the parameters of the intrinsic sub-model comprises updating the parameters of the audio encoder or the decoder.

8. The computer-implemented method of claim 7, wherein the end-to-end speech recognition model comprises a recurrent neural network-transducer (RNN-T) architecture.

9. The computer-implemented method of claim 7, wherein the operations further comprise training another modular neural network, the other modular neural network comprising the other one of the audio encoder or the decoder of the end-to-end speech recognition model.

10. The computer-implemented method of claim 1, wherein:
the backbone model comprises:
a first half feedforward layer;
a convolution layer;
a second half feedforward layer; and
a layernorm layer; and
the intrinsic sub-model comprises a stack of one or more multi-head self-attention layers.

11. The computer-implemented method of claim 10, wherein the second model configuration comprises:
the first half feedforward layer;
the stack of one or more multi-head self-attention layers;
the convolution layer;
the second half feedforward layer; and
the layernorm layer.

12. The computer-implemented method of claim 1, wherein during inference, the trained modular neural network model is configured to operate in any one of:
the first model configuration comprising only the trained backbone model and having the intrinsic sub-model removed;
the second model configuration comprising the backbone model initially trained during the initial training stage and the intrinsic sub-model having the parameters fine-tuned during the fine-tuning stage; or
a third model configuration comprising only the intrinsic sub-model having the parameters fine-tuned during the fine-tuning stage and the trained backbone model removed.

13. A system comprising:
data processing hardware; and
memory hardware in communication with the data processing hardware, the memory hardware storing instructions that when executed on the data processing hardware cause the data processing hardware to perform operations comprising:
during an initial training stage, training only a backbone model to provide a first model configuration of a modular neural network model, the first model configuration comprising only the trained backbone model;
adding an intrinsic sub-model to the trained backbone model; and
during a fine-tuning training stage:
freezing parameters of the trained backbone model; and
fine-tuning parameters of the intrinsic sub-model added to the trained backbone model while the parameters of the trained backbone model are frozen to provide a second model configuration, the second model configuration comprising the backbone model initially trained during the initial training stage and the intrinsic sub-model having the parameters fine-tuned during the fine-tuning stage.

14. The system of claim 13, wherein:
the backbone model comprises a non-attentive neural network comprising existing residual connections;
the intrinsic sub-model comprises an attention-based sub-model; and
the intrinsic sub-model is added to the trained backbone model without requiring any residual adaptors or additional residual connection other than the existing residual connections.

15. The system of claim 13, wherein the operations further comprise, after fine-tuning parameters of the intrinsic sub-model:
removing the intrinsic sub-model;
adding another intrinsic sub-model to the trained backbone model; and
during another fine-tuning training stage:
freezing parameters of the trained backbone model; and
fine-tuning parameters of the other intrinsic sub-model added to the trained backbone model while the parameters of the trained backbone model are frozen to provide a third model configuration, the third model configuration comprising the backbone model initially trained during the initial training stage and the other intrinsic sub-model having the parameters fine-tuned during the other fine-tuning stage.

16. The system of claim 15 wherein:
during the fine-tuning training stage, the parameters of the intrinsic sub-model are trained on a first domain and/or first application; or
during the other fine-tuning training stage, the parameters of the other intrinsic sub-model are trained on a second domain different than the first domain and/or a second application different than the first application.

17. The system of claim 16, wherein the trained backbone model is domain-independent.

18. The system of claim 16, wherein the first domain is associated with speech recognition in a first language and the second domain is associated with speech recognition in a second language different than the first language.

19. The system of claim 13, wherein:
the modular neural network model comprises an end-to-end speech recognition model comprising an audio encoder and a decoder;
training only the backbone model comprises updating parameters of the audio encoder or the decoder; and
fine-tuning the parameters of the intrinsic sub-model comprises updating the parameters of the audio encoder or the decoder.

20. The system of claim 19, wherein the end-to-end speech recognition model comprises a recurrent neural network-transducer (RNN-T) architecture.

21. The system of claim 19, wherein the operations further comprise training another modular neural network, the other modular neural network comprising the other one of the audio encoder or the decoder of the end-to-end speech recognition model.

22. The system of claim 13, wherein:
the backbone model comprises:
a first half feedforward layer;
a convolution layer;
a second half feedforward layer; and
a layernorm layer; and
the intrinsic sub-model comprises a stack of one or more multi-head self-attention layers.

23. The system of claim 22, wherein the second model configuration comprises:
the first half feedforward layer;
the stack of one or more multi-head self-attention layers;
the convolution layer;
the second half feedforward layer; and
the layernorm layer.

24. The system of claim 13, wherein during inference, the trained modular neural network model is configured to operate in any one of:
the first model configuration comprising only the trained backbone model and having the intrinsic sub-model removed;
the second model configuration comprising the backbone model initially trained during the initial training stage and the intrinsic sub-model having the parameters fine-tuned during the fine-tuning stage; or
a third model configuration comprising only the intrinsic sub-model having the parameters fine-tuned during the fine-tuning stage and the trained backbone model removed.
